(19) United States
(12) Patent Application Publication
(10) Pub. No.: US 2025/0245791 A1
(43) Pub. Date: Jul. 31, 2025

(54) IMAGE DENOISING WITH GUIDANCE UPDATES

(71) Applicant: Lemon Inc., Grand Cayman (KY)

(72) Inventors: Hanshu Yan, Singapore (SG); Jun Hao Liew, Singapore (SG); Jiashi Feng, Singapore (SG)

(21) Appl. No.: 18/427,364

(22) Filed: Jan. 30, 2024

(51) Int. Cl. G06T 5/70; G06T 5/60; G06T 7/55; G06T 11/00

(52) U.S. Cl. CPC G06T 5/70; G06T 5/60; G06T 7/55; G06T 11/00; G06T 2207/10016; G06T 2207/20081

(57) ABSTRACT

A computing system including one or more processing devices configured to receive an image generation prompt and a reference image. Over a plurality of denoising timesteps, the one or more processing devices compute a guided image by applying denoising updates to a generated image at a denoising diffusion model. At a subset of the denoising timesteps, computing the guided image further includes applying guidance updates to the generated image based on the image generation prompt, the reference image, and a generated image set. The one or more processing devices compute each guidance update by performing a forward pass and a backward pass in first and second integration timesteps. A size of the generated image set and numbers of the first and second integration timesteps are each equal to a predefined integration timestep count. The one or more processing devices output a final generated image computed in a final denoising timestep.

### BACKGROUND

Diffusion models are generative machine learning models that are used, for example, in image, video, and audio generation. At a diffusion model, noise is added to a data distribution in order to transform that data distribution into a simple distribution of noise, such as a Gaussian distribution. The diffusion model then computes an inverse of the noise addition process to generate a new sample of the original data distribution. Accordingly, the diffusion model computes an output such as an image, video, or sound that matches the input distribution. The input distribution may be computed from an input that has a different modality compared to the output. For example, diffusion models may be used in text-to-image synthesis by computing the input distribution from a text prompt and by computing an image as a sample from that input distribution.

### SUMMARY

According to one aspect of the present disclosure, a computing system is provided, including one or more processing devices configured to receive an image generation prompt and a reference image. Over a plurality of denoising timesteps, the one or more processing devices are further configured to compute a guided image at least in part by iteratively applying a plurality of denoising updates to a generated image at a denoising diffusion model. At a subset of the plurality of denoising timesteps, computing the guided image further includes applying respective guidance updates to the generated image based at least in part on the image generation prompt, the reference image, and a generated image set that includes a current-timestep generated image and a plurality of prior-timestep generated images. The one or more processing devices are configured to compute each guidance update at least in part by performing a forward pass over the generated image set in a plurality of first integration timesteps and performing a backward pass over the generated image set in a plurality of second integration timesteps. A size of the generated image set, a number of the first integration timesteps, and a number of the second integration timesteps are each equal to a predefined integration timestep count. The one or more processing devices are further configured to output, as the guided image, a final generated image computed in a final denoising timestep of the plurality of denoising timesteps.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system including one or more processing devices configured to generate a guided image, according to one example.

FIG. 2 schematically shows computation of a guidance update, according to the example of FIG. 1.

FIG. 3A schematically shows the computing system in additional detail when the one or more processing devices perform a forward pass, according to the example of FIG. 1.

FIG. 3B schematically shows the computing system in additional detail when the one or more processing devices perform a backward pass, according to the example of FIG. 1.

FIG. 4 schematically shows a plurality of initial denoising timesteps, a plurality of intermediate denoising timesteps, and a plurality of subsequent denoising timesteps that may be performed at the one or more processing devices when computing the guided image, according to the example of FIG. 1.

FIG. 5 schematically shows the computing system when a plurality of self-recurrence timesteps are performed at one or more denoising timesteps, according to the example of FIG. 1.

FIG. 6 shows an example algorithm that may be executed at the computing system to perform guided image generation, according to the example of FIG. 1.

FIG. 7 schematically shows the computing system in an example in which guided video generation is performed, according to the example of FIG. 1.

FIG. 8 schematically shows the computing system in an example in which a trained feedback model is used when generating the guided image, according to the example of FIG. 1.

FIG. 9A shows a flowchart of a method for use with a computing system to compute a guided image, according to the example of FIG. 1.

FIGS. 9B-9D show additional steps of the method of FIG. 9A that may be performed in some examples.

FIG. 10A shows example images generated in a style-guided sampling experiment, according to the example of FIG. 1.

FIG. 10B shows example images generated in an aesthetically guided sampling experiment, according to the example of FIG. 1.

FIG. 10C shows example images generated in an object-guided personalization sampling experiment, according to the example of FIG. 1.

FIG. 10D shows example images generated in a face-ID-guided personalization sampling experiment, according to the example of FIG. 1.

FIG. 10E shows example guided frames generated in a style-guided video editing experiment, according to the example of FIG. 1.

FIG. 11A shows example guided images generated with different values of a predefined integration timestep count, according to the example of FIG. 1.

FIG. 11B shows a plot of loss curves for different values of the predefined integration timestep count, according to the example of FIG. 1.

FIG. 11C shows example images generated at different values of a guidance strength hyperparameter, according to the example of FIG. 1.

FIG. 12 shows a schematic view of an example computing environment in which the computing system of FIG. 1 may be instantiated.

### DETAILED DESCRIPTION

In some previous approaches, guided sampling has been used with diffusion models to provide additional control over the output generation process. Guided sampling has been used to control the outputs of generative models by conditioning those outputs on various types of signals, such as descriptive text, class labels, and images.

In some prior approaches to diffusion model guidance, guided sampling has been performed using task-specific training of diffusion models on paired data that includes target outputs paired with conditions. For instance, classifier guidance combines score estimates computed at diffusion models with gradients computed at image classifiers to direct the generation process. Thus, classifier guidance trains the diffusion model to produce images corresponding to a particular class. Alternatively, classifier-free guidance directly trains a score estimator with the conditions and uses a linear combination of conditional and unconditional score estimators during sampling. Although training-based methods can effectively guide diffusion models to generate data satisfying specified properties, training-based methods of diffusion model guidance have low flexibility due to costs associated with training and potential difficulty collecting paired data.

Training-free guidance methods have also been used to perform guided sampling. In training-free guided sampling, at a certain sampling step t, a guidance function is typically constructed from the gradient of a loss function of a pretrained diffusion model. More specifically, the guidance gradient is computed based on a one-step approximation of denoised images from noisy samples at the sampling step t. The gradients are then added to corresponding sampling steps as guidance to direct the generation process. Training-free guidance methods offer greater flexibility by allowing the diffusion model to adapt to a broad spectrum of guidance. However, at some timesteps at which guidance is performed, the generated result is frequently misaligned with its one-step denoising approximation, thereby leading to inaccurate guidance. This misalignment is pronounced in the early steps of the generation process, as the noised samples are far from the final result. For example, in face ID-guided generation, when a blurry final approximation is passed to a pretrained face detection model, that pretrained face detection model typically does not output accurate identifications of features. The misalignment between the generated result and the one-step denoising approximation thereby leads to inaccurate guidance toward a specified input face.

In order to address the shortcomings of previous guided image generation approaches, a diffusion model guidance approach referred to as Symplectic Adjoint Guidance (SAG) is introduced herein. SAG is a training-free guidance method. In contrast to previous training-free guidance methods, SAG estimates the final result through n-step denoising. Multi-step sampling generates more accurate samples. However, multi-step sampling introduces the additional challenge of backpropagating gradients from the output to each intermediate sampling step. If a conventional backpropagation step were performed, that backpropagation step would require storing all the intermediate states of the n iterations, which would use prohibitively large amounts of memory. To reduce the memory used during backpropagation, SAG uses a symplectic adjoint method of numerical integration when computing guidance updates, as discussed in further detail below. Thus, SAG achieves accurate gradient backpropagation with increased memory efficiency.

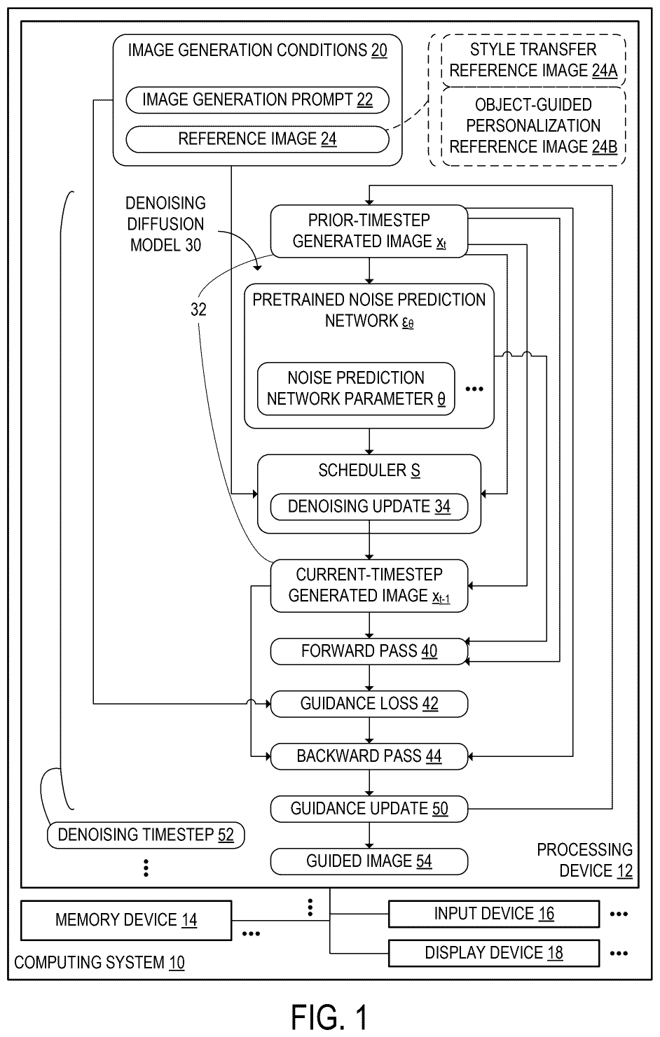

FIG. 1 schematically shows a computing system 10 including one or more processing devices 12 configured to generate a guided image 54. The one or more processing devices 12 may, for example, include one or more central processing units (CPUs), graphics processing units (GPUs), tensor units, application-specific integrated circuits (ASICs), and/or other types of processing devices 12.

The computing system 10 further includes one or more memory devices 14 coupled to the one or more processing devices 12. The one or more memory devices 14 may include volatile memory and non-volatile storage. In some examples, the computing system 10 is distributed across a plurality of physical computing devices, such as server computing devices located in one or more data centers. In other examples, the one or more processing devices 12 and the one or more memory devices 14 are included in a single physical computing device.

The example computing system 10 depicted in FIG. 1 further includes one or more input devices 16 and one or more display devices 18. One or more other types of output devices may also be included in the computing system 10. The one or more input devices 16 and the one or more display devices 18 may be included in a client computing device in some examples.

As depicted in the example of FIG. 1, the one or more processing devices 12 are configured to receive image generation conditions 20. These image generation conditions 20 include an image generation prompt 22, which may be a text prompt describing target semantic content and/or stylistic features of the guided image 54.

The image generation conditions 20 further include a reference image 24. In some examples, as shown in FIG. 1, the reference image 24 is a style transfer reference image 24A. The style transfer reference image 24A received in such examples indicates target stylistic features of the guided image 54. For example, the stylistic features may be low-level features such as a color scheme or a texture pattern. In examples in which the reference image 24 is a style transfer reference image 24A, the image generation prompt 22 specifies the semantic content of the guided image 54.

In other examples, the reference image 24 may be a subject personalization reference image 24B. The subject personalization reference image 24B specifies a target person or object indicated for inclusion in the guided image 54. For example, users may input photographs of themselves as subject personalization reference images 24B and may specify target actions (e.g., riding a bicycle) in the corresponding image generation prompts 22. In such examples, the one or more processing devices 12 are configured to generate guided images 54 depicting those users performing the specified actions. The subject personalization reference image 24B accordingly includes additional semantic data for depiction in the guided image 54.

In other examples, other types of image data may be included in the reference image 24. Types of data other than the image generation prompts 22 and reference images 24 may additionally or alternatively be used as the image generation conditions 20, as discussed in further detail below.

The one or more processing devices 12 are further configured to compute the guided image 54 at a denoising diffusion model 30 over a plurality of denoising timesteps 52. In the example of FIG. 1, the denoising diffusion model 30 is provided as a pretrained noise prediction network Ee. The noise prediction network Ee includes a plurality of noise prediction network parameters θ, which may be included in a plurality of layers of a deep neural network.

The one or more processing devices 12 are configured to progress through the plurality of denoising timesteps 52 from t=T, . . . , 0. At the plurality of denoising timesteps 52, the one or more processing devices 12 are configured to iteratively apply a plurality of denoising updates 34 to a generated image 32. The one or more processing devices 12 may be configured to execute a scheduler S that performs the denoising update 34 to compute a current-timestep generated image xₜ₋₁.

The one or more processing devices 12 are configured to perform a noising process and a denoising process during each of the denoising timesteps 52 when the denoising update 34 is applied. The forward noising process and the reverse denoising process may be performed by numerically solving respective systems of differential equations, as discussed in further detail below. The systems of differential equations may be systems of stochastic differential equations (SDEs) or ordinary differential equations (ODEs). The following discussion considers denoising diffusion models 30 that use systems of ODEs, since ODE-based diffusion models may be efficiently sampled in a deterministic manner.

A denoising diffusion implicit model (DDIM) sampling approach that may be used in the SAG method is discussed below. At a DDIM sampler, the one or more processing devices 12 are configured to solve the following ODE to perform discrete deterministic sampling:

$${x}_{t - 1} = \sqrt{{α}_{t - 1}} {\hat{x}}_{0} + \sqrt{1 - {α}_{t - 1}} {ϵ}_{θ} ( {x}_{t} , t ) \qquad ( Equation 1 )$$

In the above equation, xₜ₋₁ is a current-timestep generated image that is computed at a current denoising timestep t, and xₜ is a prior-timestep generated image that was computed at the previous denoising timestep t+1.

αₜ₋₁ is the value of a noise scheduling hyperparameter at the current denoising timestep t. Over the plurality of denoising timesteps, the one or more processing devices 12 are configured to modify the noise scheduling hyperparameter to adjust the amount of noise added to the generated image at different denoising timesteps.

The noise prediction network ϵ_{θ} is configured to reverse the noising process. At each denoising timestep 52, the noise prediction network ϵ_{θ} is configured to receive the prior-timestep generated image xₜ and the denoising timestep number t as input.

\hat{x}₀ is an estimated clean image that is computed as an approximation of a fully denoised output image. The estimated clean image \hat{x}₀ may be computed according to the following equation:

$${\hat{x}}_{0} = \frac{{x}_{t} - \sqrt{1 - {α}_{t}} {ϵ}_{θ} ( {x}_{t} , t )}{\sqrt{{α}_{t}}} \qquad ( Equation 2 )$$

Equation 1 may be parameterized using the quantity σₜ=\sqrt{1−αₜ}/\sqrt{αₜ}, since σₜ is monotone in t. With this parameterization, the quantity x̅_{σ}_{ₜ}=xₜ/\sqrt{αₜ} may also be defined. When σₜ₋₁−σₜ→0, the following ODE is obtained:

$$d {\overline{x}}_{{σ}_{t}} = \overline{ϵ} ( {\overline{x}}_{{σ}_{t}} , {σ}_{t} ) d {σ}_{t} \qquad ( Equation 3 )$$

In the above equation, ϵ̅(x̅_{σ}_{ₜ}, σₜ)=ϵ_{θ}(xₜ, t). By using the above ODE form of Equation 1, numerical methods may be used to accelerate sampling when denoising is performed. As discussed in further detail below, the SAG method provided herein modifies the computation of X, in a manner that accounts for the guidance.

Returning to the example of FIG. 1, in order to perform the denoising update 34 is performed during a denoising timestep 52, the scheduler S is configured to receive the image generation conditions 20 and the prior-timestep generated image xₜ. The scheduler S is further configured to compute the current-timestep generated image xₜ₋₁ based at least in part on an output of the noise prediction network ϵ_{θ} given those inputs. At each denoising timestep 52, the scheduler S is accordingly configured to estimate the noise in the prior-timestep generated image xₜ and remove that noise. The scheduler S may, for example, be the DDIM scheduler discussed above. Other types of denoising diffusion schedulers may be used in other examples.

The computation of a guidance update 50 according to the SAG method is discussed below. At respective denoising timesteps 52, the one or more processing devices 12 are configured to apply these guidance updates 50 to the generated image 32. Each guidance update 50 is computed based at least in part on the image generation prompt 22, the reference image 24, the current-timestep generated image xₜ₋₁, and a plurality of prior-timestep generated images xₜ. The guidance update 50 may be applied to the generated image 32 subsequently to the denoising update 34.

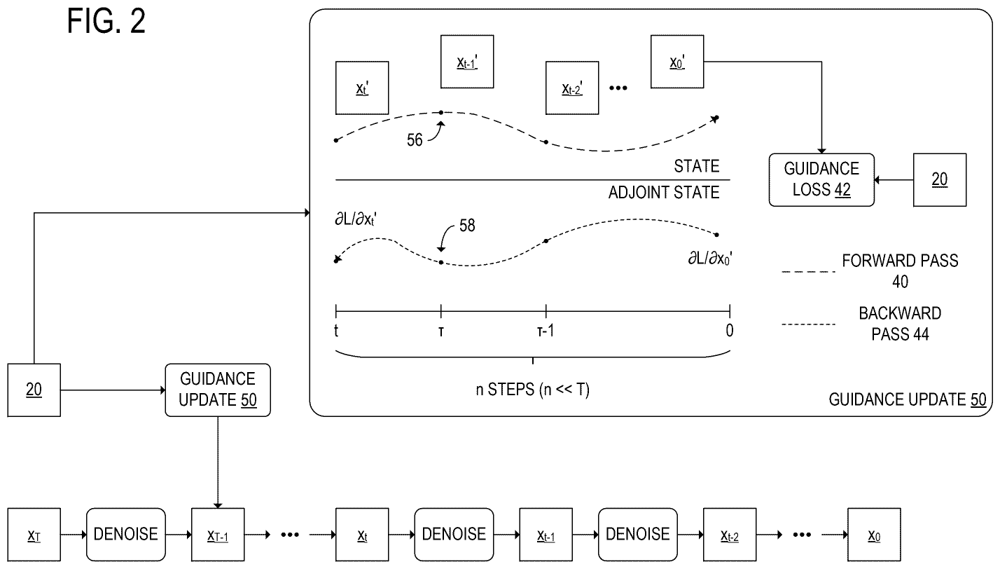

FIG. 2 schematically shows computation of the guidance update 50 according to the example of FIG. 1. When the guidance update 50 is computed, according to the example of FIG. 2, the one or more processing devices 12 are configured to perform the forward pass 40 in a plurality of first integration timesteps 56. The number of first integration timesteps 56 performed during the forward pass 40 is equal to a predefined integration timestep count n. The predefined integration timestep count n is a hyperparameter of the SAG process that is significantly smaller than the total number of denoising timesteps T. For example, n may be equal to 4 or 5. At the first integration timesteps 56, the one or more processing devices 12 are configured to compute estimates of n subsequent denoised images starting with the prior-timestep generated image xₜ and progressing to the estimated clean image \hat{x}₀. The intermediate estimates of the prior-timestep generated image xₜ within the guidance timestep 50 are denoted as xₜ′ in the example of FIG. 2, and the estimated clean image \hat{x}₀ is equal to x₀′.

The one or more processing devices 12 are further configured to compute a guidance loss 42 subsequently to performing the forward pass 40. The guidance loss 42 is computed based at least in part on the estimated clean image \hat{x}₀ and the reference image 24. For example, the guidance loss 42 may be computed as an L₂ norm between a Gram matrix of the reference image 24 and a Gram matrix of the estimated clean image \hat{x}₀.

When guided image generation is performed at the denoising diffusion model 30, a guidance function may be added to the diffusion ODE of Equation 3. The resulting guided diffusion ODE may be given as follows:

$$\frac{d {\overline{x}}_{{σ}_{t}}}{d {σ}_{t}} = \overline{ϵ} ( {\overline{x}}_{{σ}_{t}} , {σ}_{t} ) + {ρ}_{{σ}_{t}} g ( {\overline{x}}_{{σ}_{t}} , c , {σ}_{t} ) \qquad ( Equation 4 )$$

In the above equation, ρ_{σ}_{ₜ} is a guidance strength hyperparameter, c is the set of image generation conditions 20, and g(x̅_{σ}_{ₜ}, c, σₜ) is the guidance function.

The guidance function g(x̅_{σ}_{ₜ}, c, σₜ) may be computed as a negative gradient of a loss function, such that

$$g ( {\overline{x}}_{{σ}_{t}} , c , {σ}_{t} ) = - {∇}_{{\overline{x}}_{{σ}_{t}}} L ( {\overline{x}}_{{σ}_{t}} , c ) .$$

This gradient is computed as the gradient of the parameters of the pretrained denoising diffusion model 30. For example, when the reference image 24 is a style transfer reference image 24A, the loss may be a style loss between x̅_{σ}_{ₜ} and the style transfer reference image 24A. During computation of the guidance update 50, the one or more processing devices 12 are configured to perform a forward pass 40 over the set of prior-timestep generated images xₜ and the current-timestep generated image xₜ₋₁. As outputs of the forward pass 40, the one or more processing devices 12 are configured to obtain values of the loss gradient. The one or more processing devices 12 are further configured to solve the guided diffusion ODE in a backward pass 44 to compute the guidance update 50.

Since a pretrained denoising diffusion model 30 is trained with training images that do not include noise, the values of the loss gradient through the pretrained denoising diffusion model 30 may be inaccurate if used to directly obtain loss values for the noisy inputs x̅_{σ}_{ₜ}. Instead, the one or more processing devices 12 may be configured to approximate the loss

$${∇}_{{\overline{x}}_{{σ}_{t}}} L ( {\overline{x}}_{{σ}_{t}} , c )$$

using

$${∇}_{{\overline{x}}_{{σ}_{t}}} L ( {\hat{x}}_{0} ( {\overline{x}}_{{σ}_{t}} , {σ}_{t} , c ) ) ,$$

where \hat{x}₀ is the estimated clean image discussed above with reference to Equation 2. Accordingly, the one or more processing devices 12 are configured to compute the guidance loss 42.

Returning to the example of FIG. 2, the one or more processing devices 12 are further configured to perform a backward pass 44 in a plurality of second integration timesteps 58. During the backward pass 44, the one or more processing devices 12 are configured to compute a plurality of adjoint states

$${a}_{t} = \frac{\partial L}{\partial {x}_{{t}^{′}}}$$

that represent gradients of the guidance loss 42 with respect to the intermediate states xₜ′ obtained as the prior-timestep generated images. Pairs (xₜ′, aₜ) of intermediate states and corresponding adjoint states may be used as augmented states during the backward pass 44. By integrating the augmented states backward in time, as shown in the example of FIG. 2, the one or more processing devices 12 may be configured to compute respective gradient estimates at the second integration timesteps 58.

In one previous approach to guided image generation, the following backward ODE has been used to obtain gradients with respect to intermediate states x̅_{σ}_{ₜ}:

$$d [ \frac{\begin{matrix}{\overline{x}}_{{σ}_{t}} \\ \partial L\end{matrix}}{\partial {\overline{x}}_{{σ}_{t}}} ] = [ \begin{matrix}\overline{ϵ} ( {\overline{x}}_{{σ}_{t}} , {σ}_{t} ) \\ \begin{matrix}- {( \frac{\partial \overline{ϵ} ( {\overline{x}}_{{σ}_{t}} , {σ}_{t} )}{\partial {\overline{x}}_{{σ}_{t}}} )}^{T} & \frac{\partial L}{\partial {\overline{x}}_{{σ}_{t}}}\end{matrix}\end{matrix} ] d {σ}_{t} \qquad ( Equation 5 )$$

Subsequently to obtaining the gradients

$$\frac{\partial L}{\partial {\overline{x}}_{{σ}_{t}}}$$

by solving the above differential equation, the gradients

$$\frac{\partial L}{\partial {x}_{{t}^{′}}}$$

may be computed as

$$\frac{\partial L}{\partial {x}_{{t}^{′}}} = \frac{1}{\sqrt{{α}_{t}}} \frac{\partial L}{\partial {\overline{x}}_{{σ}_{t}}}$$

using the definition of x̅_{σ}_{ₜ}. However, this previous approach to backpropagation with adjoint states frequently results in large errors when the above differential equation is numerically solved. Reducing these errors via the conventional approach of reducing the step size leads to significantly increased computational costs. To avoid these errors and computational cost increases, the SAG approach uses a symplectic adjoint method of solving differential equations, as discussed in further detail below.

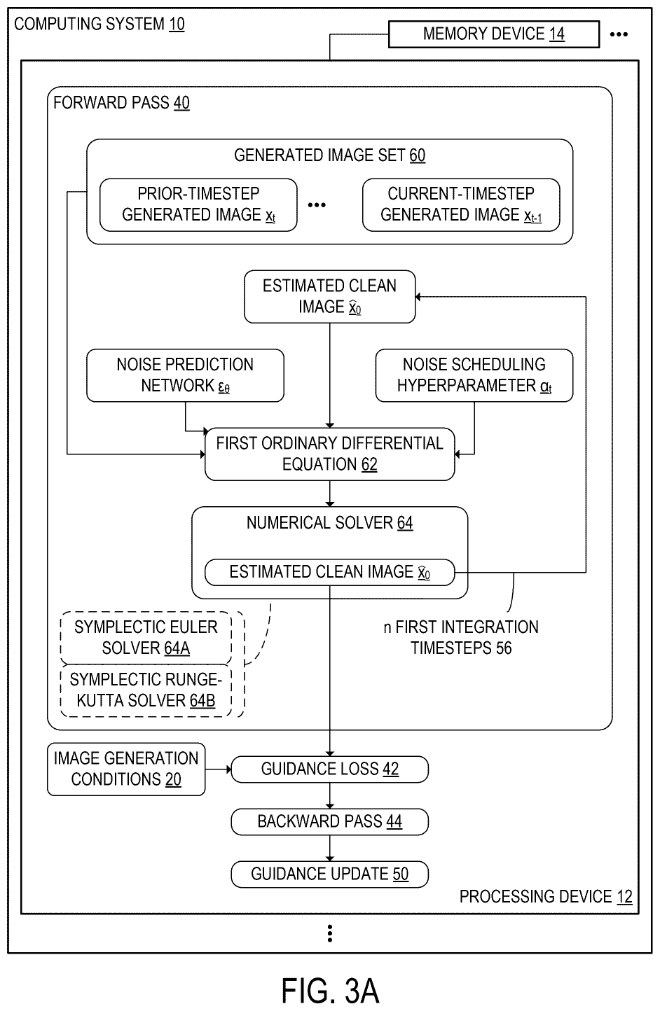

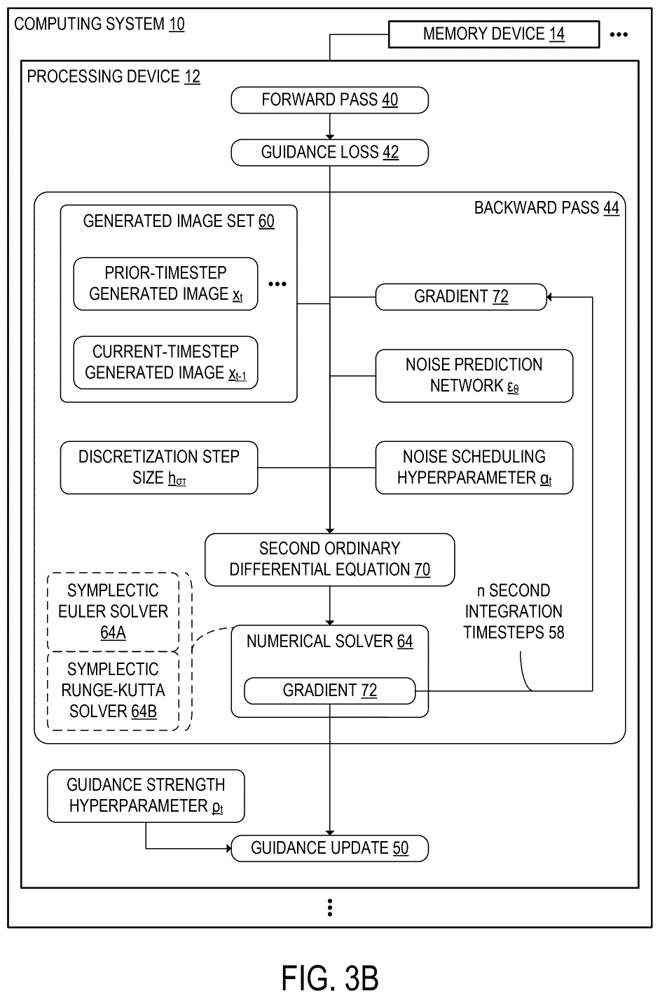

FIG. 3A schematically shows the computing system 10 in additional detail when the one or more processing devices 12 perform the forward pass 40. The forward pass 40 is performed based at least in part on a generated image set 60 that includes the current-timestep generated image xₜ₋₁ and a plurality of prior-timestep generated images xₜ. The current-timestep generated image xₜ₋₁ and the prior-timestep generated images xₜ are used to compute the estimated clean image \hat{x}₀.

As discussed above, when only one prior-timestep generated image xₜ is used to compute the estimated clean image \hat{x}₀, as in prior image guidance approaches, the estimated clean image \hat{x}₀ and the final output image are frequently misaligned, thereby producing image artifacts. This misalignment is particularly severe early at early denoising iterations, when the noised samples x̅_{σ}_{ₜ} are far from the final outputs. However, using a plurality of prior-timestep generated images xₜ in addition to the current-timestep generated image xₜ₋₁ during the forward pass avoids misalignment between the estimated clean image \hat{x}₀ and the guided image 54.

Since explicitly utilizing all the generated images 32 included in the generated image set 60 at each instance of the forward pass 40 would use large amounts of memory, the one or more processing devices 12 are instead configured to iteratively compute the estimated clean image \hat{x}₀ over the plurality of first integration timesteps 56 by numerically solving a first ordinary differential equation (ODE) 62. The noise prediction network ϵ_{θ}, the noise scheduling hyperparameter αₜ, the current-timestep generated image xₜ₋₁, the prior-timestep generated image xₜ from the immediately preceding denoising timestep 52, and the current value of the estimated clean image \hat{x}₀ are used as inputs when solving the first ODE 62.

The first ODE 62 may be given as follows:

$$\frac{{x}_{τ − 1}^{′}}{\sqrt{{α}_{τ − 1}}} = \frac{{x}_{τ}^{′}}{\sqrt{{α}_{τ}}} + {ϵ}_{θ} ( {x}_{τ}^{′} , τ ) ( \sqrt{\frac{1 − {α}_{τ − 1}}{{α}_{τ − 1}}} − \sqrt{\frac{1 − {α}_{τ}}{{α}_{τ}}} ) \qquad ( Equation 6 )$$

In the above first ODE 62, t=n, . . . , 1 is the current first integration timestep 56. x_{τ}′ is an intermediate state of the process of predicting the estimated clean image \hat{x}₀. At the beginning of the clean image estimation process, the one or more processing devices are configured to set xₙ′=xₜ. In addition, at the end of the clean image estimation process, x₀′=\hat{x}₀. Equation 6 is a discretized form of Equation 3.

As depicted in the example of FIG. 3A, the one or more processing devices 12 are configured to execute a numerical solver 64 to solve the first ODE 62. The numerical solver 64 is configured to use a symplectic solving approach. For example, the numerical solver 64 may be a symplectic Euler solver 64A configured to perform a symplectic Euler method, or a symplectic Runge-Kutta solver 64B configured to perform a symplectic Runge-Kutta method. Equation 6 provides the update rule of the numerical solver 64 in an example in which the numerical solver 64 is a symplectic Euler solver 64A. At the numerical solver 64, the one or more processing devices 12 are configured to iteratively incorporate data from the prior-timestep generated images xₜ into the computation of the estimated clean image \hat{x}₀ without having to concurrently store multiple prior-timestep generated images xₜ in volatile memory.

FIG. 3B schematically shows the computing system 10 in additional detail when a gradient 72 of the guidance loss 42 is computed during the backward pass 44 using the symplectic adjoint method. The gradient 72 computed in the example of FIG. 3B may be expressed as ∇ₓ_{ₜ}L(x₀′, c). As depicted in FIG. 3B, performing the backward pass 44 includes numerically solving a second ODE 70 over the plurality of second integration timesteps 58. The number of second integration timesteps 58 is also equal to the predefined integration timestep count n.

The one or more processing devices 12 are configured to perform the backward pass 44 over the generated image set 60. The guidance loss 42, the noise prediction network ϵ_{θ}, and the noise scheduling hyperparameter αₜ are also used as inputs to the second ODE 70. The inputs to the second ODE 70 further include a discretization step size h_{σ}_{_{τ}}. Over the plurality of second integration timesteps 58, the one or more processing devices 12 are configured to iteratively compute the gradient 72 and use the computed value of the gradient 72 as input to a subsequent second integration timestep 58.

In an example in which the numerical solver 64 is a symplectic Euler solver 64A, an update rule given by the following equations may be used to solve the second ODE 70 given by Equation 5:

$${\overline{x}}_{{σ}_{τ + 1}}^{′} = {\overline{x}}_{{σ}_{τ}}^{′} + {h}_{{σ}_{τ}} \overline{ϵ} ( {\overline{x}}_{{σ}_{τ + 1}}^{′} , {σ}_{τ + 1} ) \qquad ( Equation 7 )$$

$$\frac{\partial L}{\partial {\overline{x}}_{{σ}_{τ + 1}}^{′}} = \frac{\partial L}{\partial {\overline{x}}_{{σ}_{τ}}^{′}} - {{h}_{{σ}_{τ}} ( \frac{\partial \overline{ϵ} ( {\overline{x}}_{{σ}_{τ + 1}}^{′} , {σ}_{τ + 1} )}{\partial {\overline{x}}^{′}} )}^{T} \frac{\partial L}{\partial {\overline{x}}_{{σ}_{τ}}^{′}} \qquad ( Equation 8 )$$

Equations 7 and 8 are a discretized form of Equation 5. In the above Equations 7 and 8, x̅_{σ}_{ₜ} are estimated values of x̅_{σ}_{_{T}} computed at respective second integration timesteps 58. The one or more processing devices 12 are configured to iteratively compute the gradient

$$\frac{\partial L}{\partial {\overline{x}}_{{σ}_{τ + 1}}^{′}}$$

for τ=0, 1, . . . , n−1. Subsequently to obtaining

$$\frac{\partial L}{\partial {\overline{x}}_{{σ}_{n}}^{′}} ,$$

the one or more processing devices 12 are further configured to compute

$$\frac{\partial L}{\partial {x}_{{t}^{′}}} = \frac{1}{\sqrt{{α}_{t}}} \frac{\partial L}{\partial {\overline{x}}_{{σ}_{n}}^{′}} .$$

In contrast to previous adjoint guidance methods, in which ϵ̅(x̅_{σ}_{_{τ}}′, σ_{τ}) is used to update x̅_{σ}_{_{τ+1}}′ and

$$\frac{\partial L}{\partial {\overline{x}}_{{σ}_{τ + 1}}^{′}} ,$$

the SAG method uses ϵ̅(x̅_{σ}_{_{τ+1}}′, σ_{τ+1}) to update x̅_{σ}_{_{τ+1}}′ and

$$\frac{\partial L}{\partial {\overline{x}}_{{σ}_{τ + 1}}^{′}} .$$

The values of x̅_{σ}_{_{τ+1}}′ used in the backward pass 44 are restored from those that are computed in the forward pass 40.

For a gradient

$$\frac{\partial L}{\partial {\overline{x}}_{{σ}_{τ}}^{′}}$$

computed as an analytical solution to the continuous ODE of Equation 5 and a gradient

$$\frac{\partial L}{\partial {\overline{x}}_{{σ}_{n}}^{′}}$$

computed using the symplectic Euler solver 64A of Equation 8,

$$\frac{\partial L}{\partial {\overline{x}}_{{σ}_{t}}^{′}} = \frac{\partial L}{\partial {\overline{x}}_{{σ}_{n}}^{′}}$$

under a set of regularity conditions. These regularity conditions specify that a quantity S(δ, λ)=λ^{T}δ is time-invariant, where

$$δ = \frac{\partial {\overline{x}}_{{σ}_{τ}}^{′}}{\partial {\overline{x}}_{{σ}_{t}}^{′}} and λ ( {σ}_{t} ) = \frac{\partial L}{\partial {\overline{x}}_{{σ}_{t}}^{′}} .$$

Subsequently to computing the gradient 72 in the backward pass 44, the one or more processing devices 12 are further configured to compute each of the guidance updates 50 as a product of a guidance strength hyperparameter ρₜ and the gradient 72 of the guidance loss 42. In some examples, the guidance strength hyperparameter ρₜ varies over the course of the plurality of denoising timesteps 52, whereas in other examples, the guidance strength hyperparameter ρₜ is held constant. The guidance strength hyperparameter ρₜ indicates an amount by which the one or more processing devices 12 are configured to scale the gradient 72 when applying the guidance update 50 to the current-timestep generated image xₜ₋₁.

Returning to the example of FIG. 1, the one or more processing devices 12 are configured to output, as the guided image 54, a final generated image 32 computed in a final denoising timestep 52 of the plurality of denoising timesteps 52. The guided image 54 may be output to a display device 18 included in the computing system 10. In some examples, the one or more processing devices 12 may be configured to transmit the guided image 54 over a network to a client computing device.

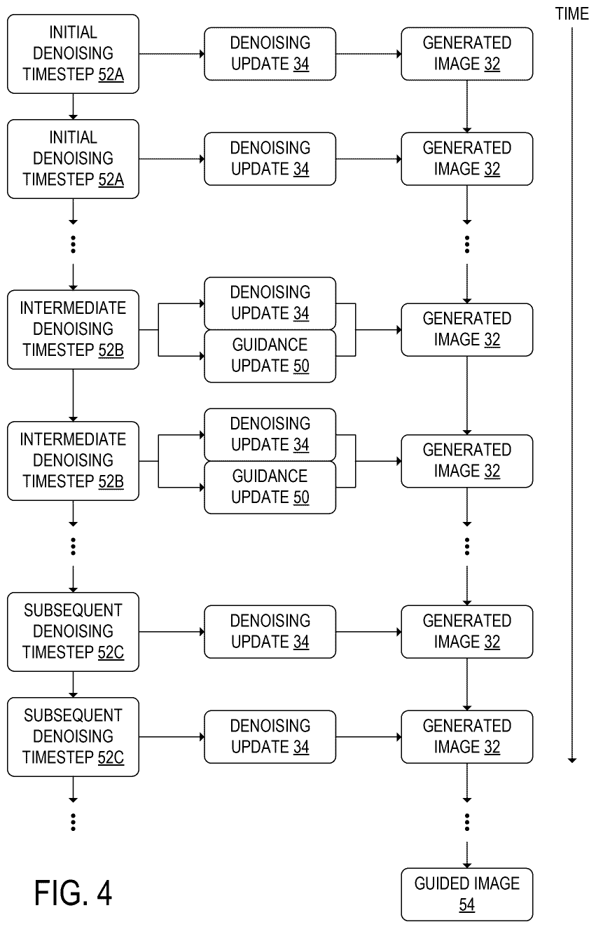

In some examples, as shown in FIG. 4, the one or more processing devices 12 may be configured to compute the guided image 54 in a plurality of initial denoising timesteps 52A, a plurality of intermediate denoising timesteps 52B, and a plurality of subsequent denoising timesteps 52C. The one or more processing devices 12 may be configured to apply the guidance updates 50 at the plurality of intermediate denoising timesteps 52B. In such examples, respective guidance updates 50 are not performed at the initial denoising timesteps 52A or the subsequent denoising timesteps 52C. Early in the denoising diffusion process, the generated images 32 are less informative about the final output image than in later denoising timesteps 52. Late in the denoising diffusion process, the generated images 32 undergo little change between denoising timesteps 52. By performing guidance during the plurality of intermediate denoising timesteps 52B, the one or more processing devices 12 accordingly time the guidance to have increased influence on the guided image 54 compared to earlier and later phases of the plurality of denoising timesteps 52. Guidance may, for example, be performed from 30% to 70% of the way through the total number T of denoising timesteps 52, or from 20% to 60% of the way through. Other ranges of denoising timesteps 52 may be used as the intermediate denoising timesteps 52B in other examples.

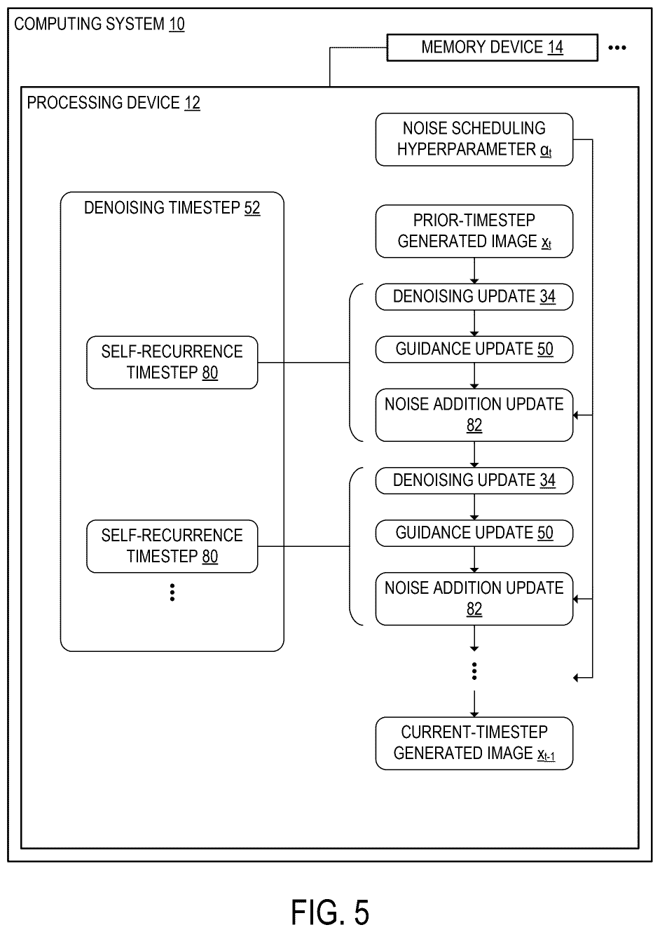

In some examples, as schematically shown in FIG. 5, the one or more processing devices 12 may be configured to perform a plurality of self-recurrence timesteps 80 at one or more of the denoising timesteps 52. In each of these self-recurrence timesteps 80 (also referred to as time travel steps), the one or more processing devices 12 may be further configured to repeat denoising and noise addition for the generated image 32. Accordingly, the one or more processing devices 12 may be configured to perform multiple denoising updates 34 and corresponding noise addition updates 82 during a denoising timestep 52. Each noise addition update 82 includes adding noise to the prior-timestep generated image xₜ. By performing a plurality of self-recurrence timesteps during a denoising timestep 52, the one or more processing devices 12 may be configured to reduce visual artifacts that would otherwise occur as a result of adding the guidance update 50 to the generated image 32.

The one or more processing devices 12 may be configured to compute and apply the guidance update 50 at one or more of the self-recurrence timesteps 80. The one or more self-recurrence timesteps 80 for which the guidance updates 50 are performed may occur during the intermediate denoising timesteps 52B. In contrast, the one or more processing devices 12 may be configured to not perform the guidance updates 50 during the self-recurrence timesteps 80 that occur during the initial denoising timesteps 52A and the subsequent denoising timesteps 52C.

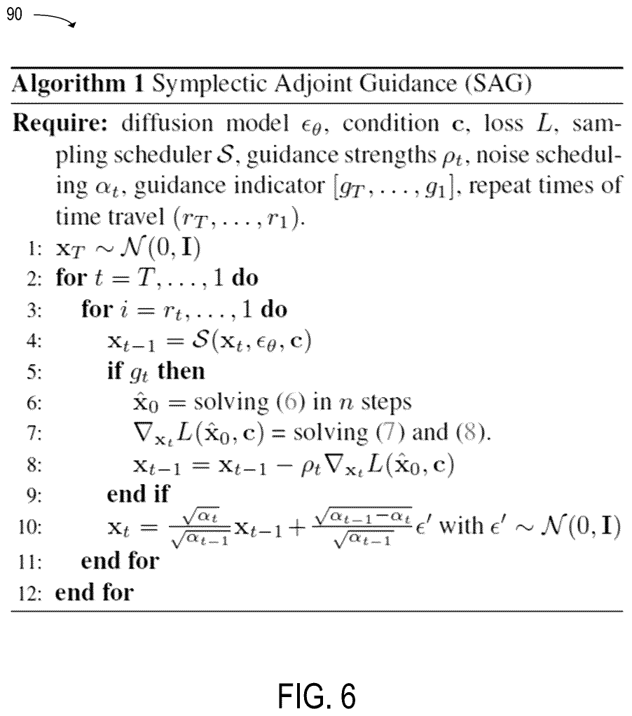

FIG. 6 shows an example algorithm 90 that may be executed at the computing system 10 to perform guided image generation. The algorithm 90 receives, as inputs, a pretrained noise prediction network ϵ_{θ}, image generation conditions c, a loss function L, a sampling scheduler S, a guidance strength hyperparameter ρₜ, a noise scheduling hyperparameter αₜ, a guidance indicator array [g_{T}, . . . , g₁], and a plurality of self-recurrence repeat times (r_{T}, . . . , r₁). The guidance indicator array [g_{T}, . . . , g₁] specifies the denoising timesteps 52 at which the guidance updates 50 are performed. Thus, the guidance indicator array [g_{T}, . . . , g₁] may specify the plurality of intermediate denoising timesteps 52B. The self-recurrence repeat times (r_{T}, . . . , r₁) are the numbers of self-recurrence timesteps 80 performed during respective denoising timesteps 52.

In the algorithm 90, an initial generated image x_{T} is sampled from a normal distribution [symbol] (0, I), where I is an identity matrix. Subsequently to initializing x_{T}, the algorithm includes a first loop over denoising timesteps t=T, . . . , 1.

Each iteration of the first loop of the algorithm 90 includes one or more iterations of a second loop of self-recurrence timesteps i=rₜ, . . . , 1. At each self-recurrence timestep i, the algorithm 90 includes updating a current-timestep generated image xₜ₋₁ by sampling at the scheduler [symbol] , such that xₜ₋₁= [symbol] (xₜ, ϵ_{θ}, c). Thus, a denoising update 34 is performed on the prior-timestep generated image xₜ.

Subsequently to performing the denoising update 34 during the self-recurrence timestep i, the algorithm 90 further includes checking whether the guidance indicator gₜ for the current denoising timestep t is set to True. If gₜ is true, the algorithm further includes computing an estimated clean image \hat{x}₀ in a forward pass 40 by solving Equation 6 over n integration timesteps. n is a predefined integration timestep count.

The algorithm 90 further includes computing a loss gradient ∇ₓ_{ₜ}L(\hat{x}₀, c) by solving Equation 7 and Equation 8. The loss gradient ∇ₓ_{ₜ}L(\hat{x}₀, c) is also computed over n integration timesteps. Subsequently to computing the loss gradient, the algorithm 90 further includes updating the current-timestep generated image xₜ₋₁ by subtracting a guidance update 50 given by ρₜ∇ₓ_{ₜ}L(\hat{x}₀, c) from the current-timestep generated image xₜ₋₁.

During the self-recurrence timestep i, the algorithm 90 further includes a noise addition update 82. During the noise addition update 82, the algorithm 90 includes updating the prior-timestep generated image xₜ according to the following equation:

$${x}_{t} = \frac{\sqrt{{α}_{t}}}{\sqrt{{α}_{t − 1}}} {x}_{t − 1} + \frac{\sqrt{{α}_{t − 1} − {α}_{t}}}{\sqrt{{α}_{t − 1}}} {ϵ}^{′} \qquad ( Equation 9 )$$

In the above equation, ϵ′ is sampled from the normal distribution [symbol] (0, I). Thus, the self-recurrence timestep i includes preparing the prior-timestep generated image xₜ for a subsequent self-recurrence timestep.

The values of the prior-timestep generated image xₜ and the current-timestep generated image xₜ₋₁ computed in the last self-recurrence timestep i of a denoising timestep t are the values of xₜ and xₜ₋₁ that may be used in a subsequent denoising timestep t. The value of xₜ₋₁ computed in the last denoising timestep is output as the guided image 54.

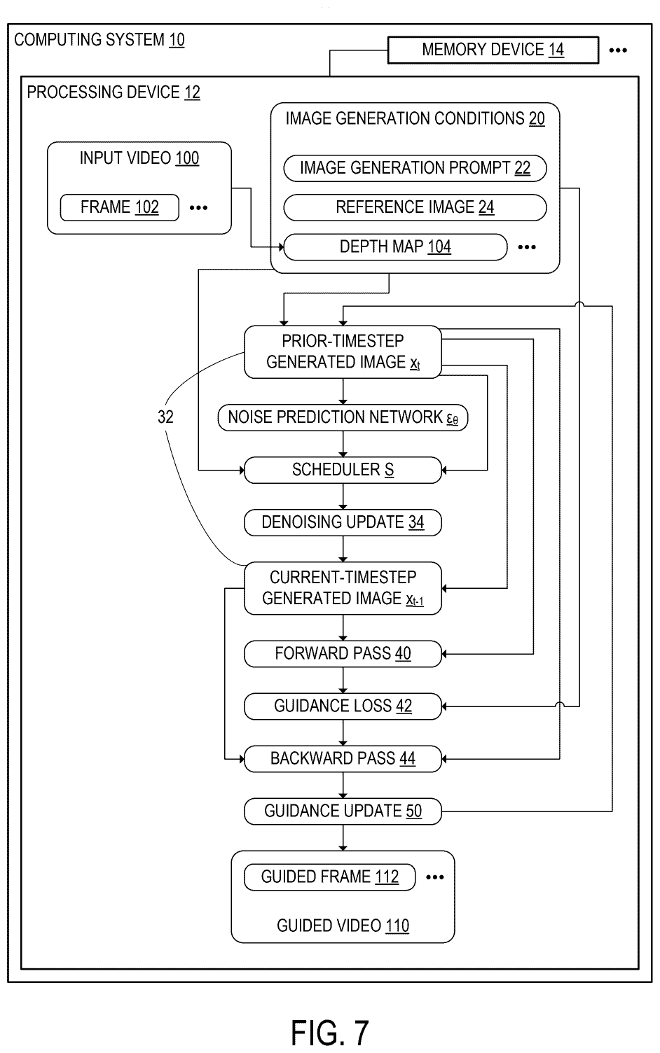

FIG. 7 schematically shows the computing system 10 in an example in which guided video generation is performed. In the example of FIG. 7, the one or more processing devices 12 are further configured to receive an input video 100 that includes a plurality of frames 102. The one or more processing devices 12 are further configured to compute respective depth maps 104 of the frames 102 of the input video 100.

In the example of FIG. 7, the one or more processing devices 12 are further configured to compute a guided video 110 based at least in part on the depth maps 104. The depth maps 104 are included among the image generation conditions 20 with which the one or more processing devices 12 are configured to condition the denoising process. In the example of FIG. 7, the image generation conditions 20 further include an image generation prompt 22 and a reference image 24. The guided video 110 computed in the example of FIG. 7 includes a plurality of guided frames 112 that may be computed using the guided image generation techniques discussed above. For example, the one or more processing devices 12 may be configured to perform style transfer or object-guided personalization from the reference image 24 onto the guided frames 112 of the guided video 110. The one or more processing devices 12 may also match the guided video 110 to a text description provided as the image generation prompt 22.

The one or more processing devices 12 are further configured to output the guided video 110. For example, the guided video 110 may be presented for display at a display device 18.

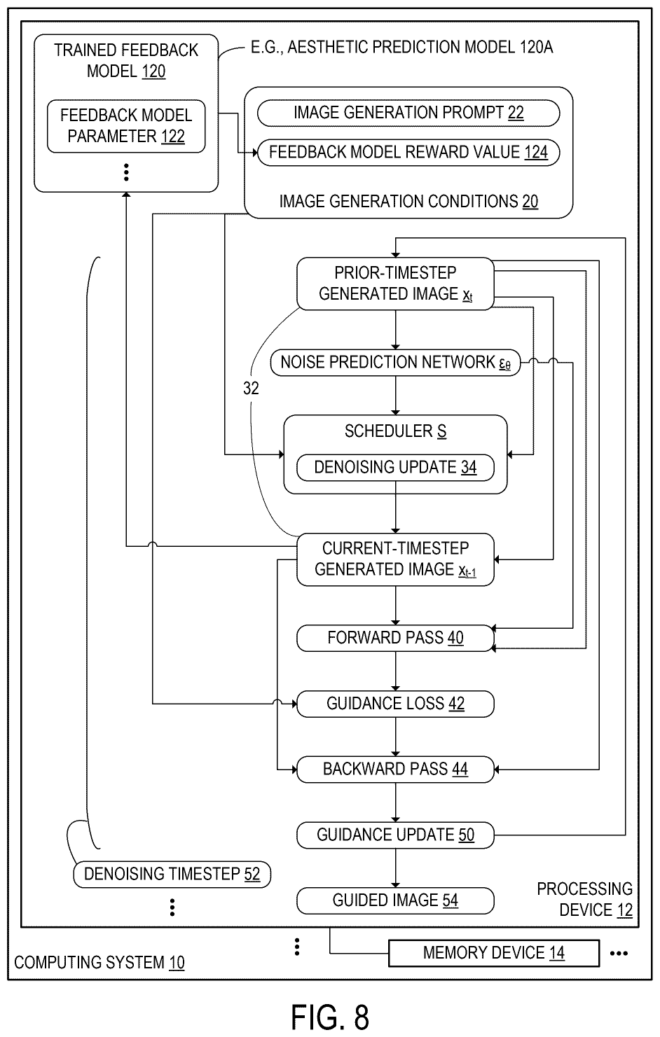

In some examples, as depicted in FIG. 8, the one or more processing devices 12 are configured to make use of a trained feedback model 120 when generating the guided image 54. The trained feedback model 120 may be a predictive model that includes a plurality of feedback model parameters 122. For example, the trained feedback model 120 may be an aesthetic prediction model 120A that has been trained to predict aesthetic evaluations of human scorers.

At the subset of the plurality of denoising timesteps 52 at which guidance is performed, the one or more processing devices 12 may be further configured to compute a feedback model reward value 124 based at least in part on the current-timestep generated image xₜ₋₁. The feedback model reward value 124 may be computed at least in part by inputting the current-timestep generated image xₜ₋₁ into the trained feedback model 120. The feedback model reward value 124 may then be included in the image generation conditions 20. Thus, the feedback model reward value 124 may be utilized when computing the denoising update 34 and the guidance loss 42. In examples in which the feedback model 120 is an aesthetic prediction model 120A, the feedback model reward value 124 may be used to guide the computation of the guided image 54 toward images that are predicted to have high aesthetic value, as indicated by their feedback model reward values 124.

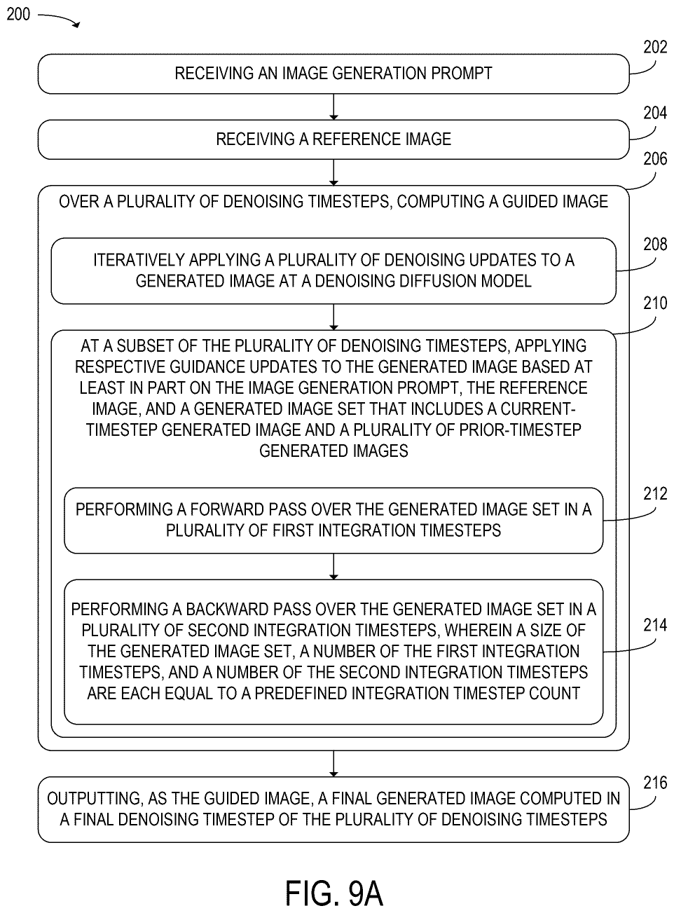

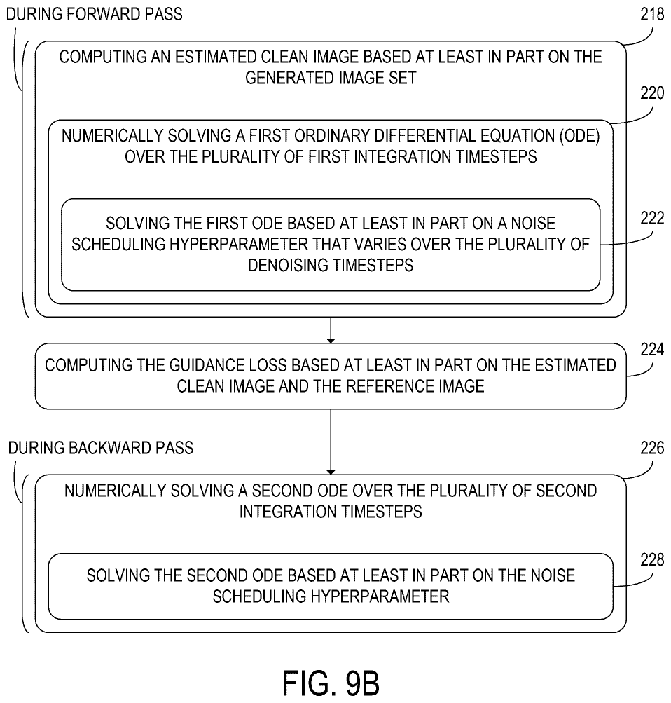

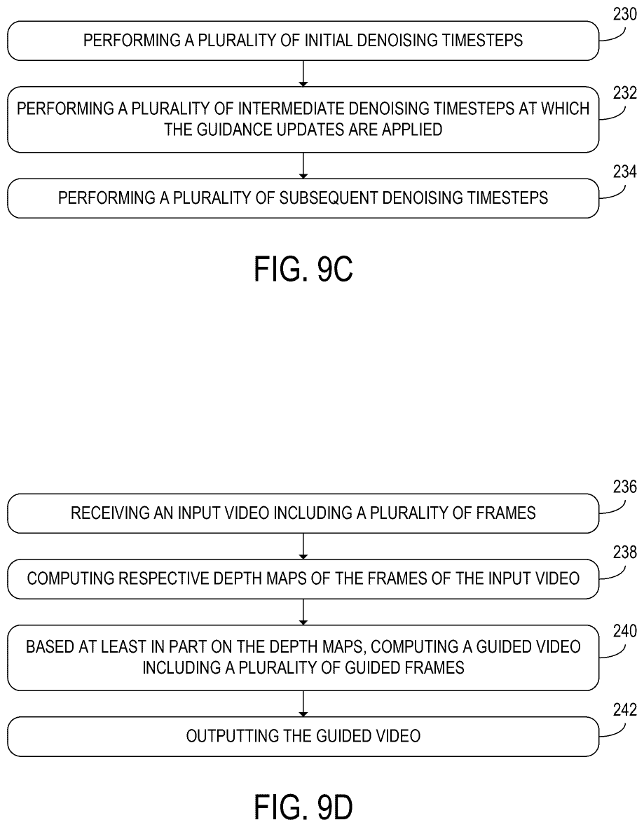

FIG. 9A shows a flowchart of a method 200 for use with a computing system to compute a guided image according to the SAG approach. At step 202, the method 200 includes receiving an image generation prompt. The image generation prompt may be a text prompt that specifies an image generation condition for the guided image. At step 204, the method 200 further includes receiving a reference image as an additional image generation condition. The reference image may, for example, be a style transfer reference image or a subject personalization reference image.

At step 206, the method 200 further includes computing a guided image over a plurality of denoising timesteps. Performing these denoising timesteps includes, at step 208, iteratively applying a plurality of denoising updates to a generated image at a denoising diffusion model. The denoising diffusion model is a pretrained noise prediction network that has been trained to reverse a noising process. The denoising updates may be computed at a scheduler that performs a sampling process conditioned on the image generation prompt and the reference image.

At step 210, step 206 further includes applying respective guidance updates to the generated image at a subset of the plurality of denoising timesteps. These guidance updates are applied based at least in part on the image generation prompt, the reference image, and a generated image set that includes a current-timestep generated image and a plurality of prior-timestep generated images. Each guidance update is computed as a modification to the current-timestep generated image. For example, each of the guidance updates may be computed as a product of a guidance strength hyperparameter and a gradient of a guidance loss.

Step 210 includes, at step 212, performing a forward pass over the generated image set in a plurality of first integration timesteps. The guidance loss may be computed subsequently to performing the forward pass. In addition, at step 214, step 210 further includes performing a backward pass over the generated image set in a plurality of second integration timesteps. The backward pass may output the gradient of the guidance loss. A size of the generated image set, a number of the first integration timesteps, and a number of the second integration timesteps are each equal to a predefined integration timestep count. The predefined integration timestep count is a hyperparameter of the SAG method that may, for example, be equal to 4 or 5.

At step 216, the method 200 further includes outputting, as the guided image, a final generated image computed in a final denoising timestep of the plurality of denoising timesteps. The guided image may be output to a display device. In some examples, the guided image may be computed at a first physical computing device (e.g., a server computing device) and output for display at a second computing device (e.g., a client computing device).

FIG. 9B shows additional steps of the method 200 that may be performed when computing the guidance update at step 208. Step 218, as depicted in FIG. 9B, may be performed during the forward pass of step 212. At step 218, step 208 may further include computing an estimated clean image based at least in part on the generated image set. The estimated clean image is an approximation of the final generated image. Step 218 may include, at step 220, numerically solving a first ordinary differential equation (ODE) over the plurality of first integration timesteps. For example, the first ODE may be solved using a symplectic Euler method or a symplectic Runge-Kutta method. At step 222, step 220 may include solving the first ODE based at least in part on a noise scheduling hyperparameter that varies over the plurality of denoising timesteps. The noise scheduling hyperparameter may be varied in order to adjust the size of the guidance updates over the course of the guided image generation process.

At step 224, step 208 may further include computing the guidance loss based at least in part on the estimated clean image and the reference image. For example, the guidance loss may be computed as the L₂ norm between a Gram matrix of the reference image and a Gram matrix of the estimated clean image.

Step 226 may be performed during the backward pass of step 214. At step 226, the method 200 may further include numerically solving a second ODE over the plurality of second integration timesteps. The second ODE may also be solved using a symplectic Euler method or a symplectic Runge-Kutta method. At step 228, step 226 may include solving the second ODE based at least in part on the noise scheduling hyperparameter. Accordingly, when the noise scheduling hyperparameter is used to compute the guidance update, the noise scheduling hyperparameter values at the corresponding denoising timesteps are utilized in both the forward pass and backward pass.

FIG. 9C shows additional steps of the method 200 that are performed in some examples when the plurality of denoising timesteps are performed at step 206. At step 230, the method 200 may include performing a plurality of initial denoising timesteps. No guidance updates are applied to the generated images during the initial timesteps. At step 232, the method 200 may further include performing a plurality of intermediate denoising timesteps at which the guidance updates are applied. At step 234, the method 200 may further include performing a plurality of subsequent denoising timesteps in which guidance updates are not applied. Thus, the guidance updates may be performed in an intermediate phase of image generation, during which the guidance updates may have more significant effects on the final generated image compared to an initial phase and a subsequent phase. The intermediate phase may, for example, include the denoising timesteps performed from 30% to 70% of the way through the plurality of denoising timesteps, or from 20% of 60% of the way through.

FIG. 9D shows steps of the method 200 that may be performed in examples in which a guided video is generated. At step 236, the method 200 may further include receiving an input video including a plurality of frames. At step 238, the method 200 may further include computing respective depth maps of the frames of the input video. The plurality of depth maps may be included among the image generation conditions along with the reference image and the image generation prompt.

At step 240, based at least in part on the depth maps, the method 200 may further include computing a guided video including a plurality of guided frames. For example, when the reference image is a style transfer reference image, the guided frames may be guided images to which the style of the reference image has been transferred in a manner than maintains depth relationships between regions of the frames of the input video. At step 240, the method 200 further includes outputting the guided video.

Experimental results for the SAG method are discussed below. In a first experiment, style-guided sampling was performed using style transfer reference images. To perform style-guided sampling, features from the third layer of a pretrained CLIP image encoder were used as a feature vector. The loss function was the L₂ norm between the Gram matrix of the style transfer reference image and the Gram matrix of the estimated clean image, as computed using the CLIP feature vectors. Stable Diffusion was used as the denoising diffusion model, and the pretrained integration timestep count was set to n=4. The number of denoising timesteps was set to T=100, with guidance applied from steps t=70 to t=31. The numbers of self-recurrence iterations were set to rₜ=1 from denoising timesteps 70 to 61 and set to rt=2 from denoising timesteps 60 to 31.

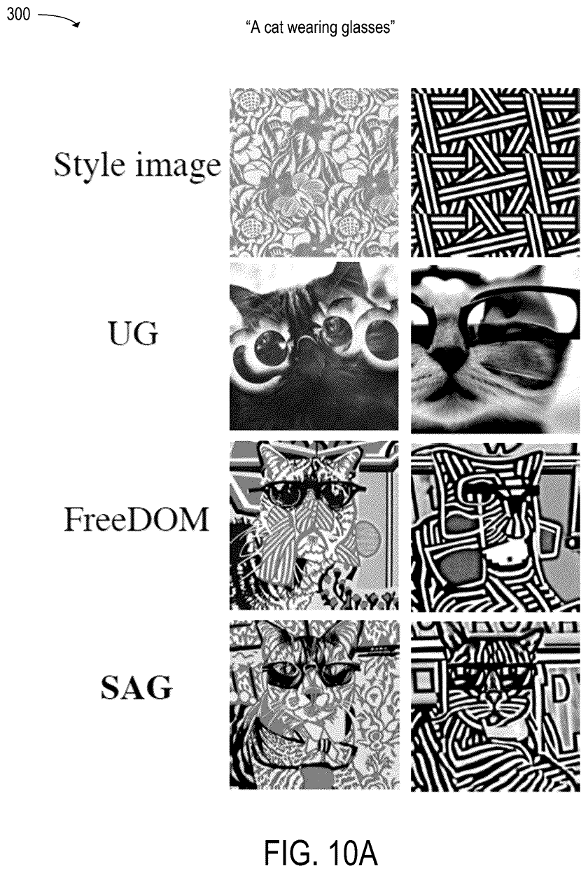

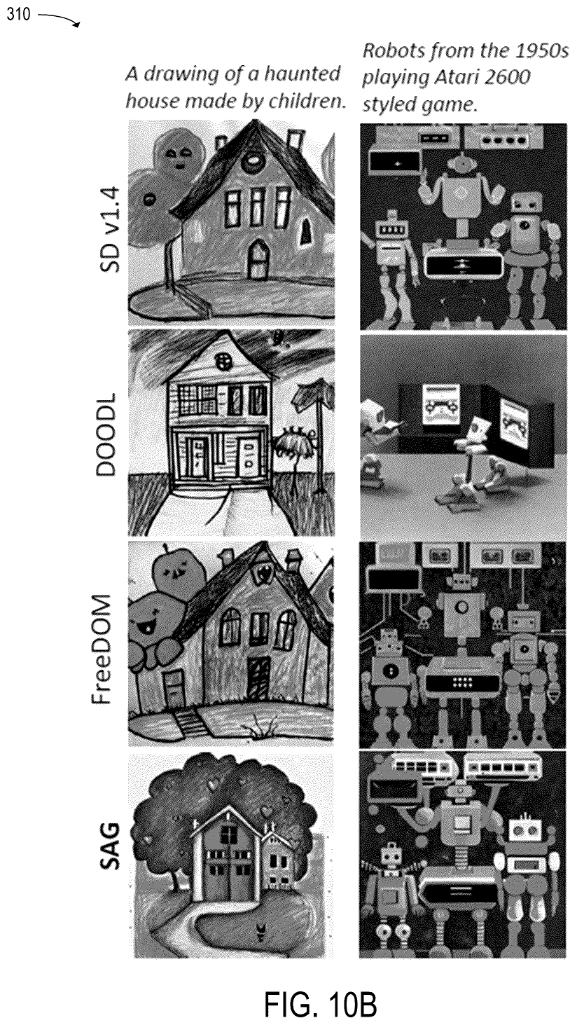

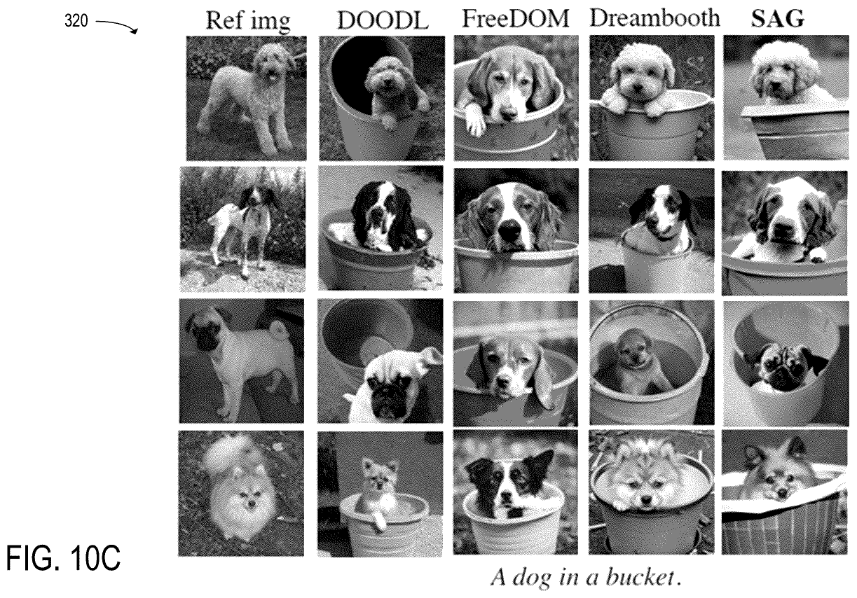

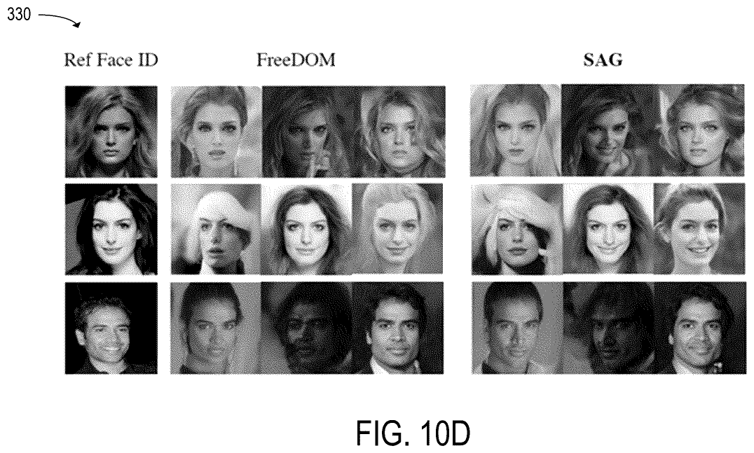

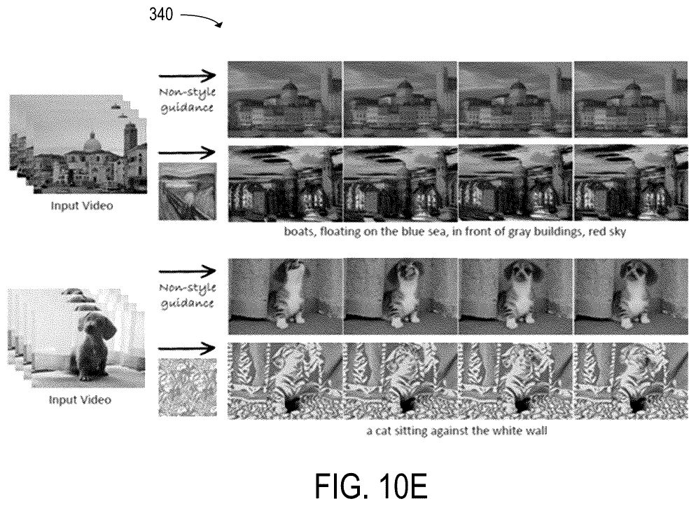

Style-guided images generated with SAG were compared to results obtained with the Free conditional Diffusion Model (FreeDoM) approach, as well as to results obtained with the Universal Guidance (UG) approach. To obtain quantitative results for the three guided image generation techniques, five style images and four prompts were randomly selected. For each technique, five images per style and per prompt were generated. FIG. 10A shows example images 300 generated for two different style images when the image generation prompt was “A cat wearing glasses.”

The following table shows quantitative results obtained in the style-guided sampling experiment:

| Method | Style loss (↓) | CLIP (↑) |
|---|---|---|
| FreeDoM | 482.7 | 22.37 |
| UG | 805 | 23.02 |
| SAG | 386.6 | 23.51 |

As shown in the above table, SAG obtained the highest performance of the three techniques in terms of both style loss and CLIP score.

In a second experiment, SAG was tested on an aesthetically guided sampling task. SAG was tested with LAION, PickScore, and HPSv2 as aesthetic prediction models. The LAION aesthetic predictor is a linear head pre-trained on top of CLIP visual embeddings to predict a value ranging from 1 to 10, which indicates the predicted aesthetic quality of an image. PickScore and HPSv2 are two reward functions trained on human preference data. In the aesthetically guided sampling experiment, Stable Diffusion was used as the denoising diffusion model, and the pretrained integration timestep count was set to n=4. The feedback model reward value was computed as a weighted sum of the scores output by LAION, PickScore, and HPSv2, with weights of 10, 2, and 0.5, respectively. The number of denoising timesteps was set to T=100, with guidance applied from steps t=70 to t=31. The numbers of self-recurrence iterations were set to rₜ=2 from denoising timesteps 70 to 41 and set to rₜ=1 from denoising timesteps 40 to 31.

In the aesthetically guided sampling experiment, ten prompts were randomly selected from four prompt categories: animation, concept art, paintings, and photos. One image was generated for each prompt. The resulting weighted aesthetic scores of all generated images were compared to baseline Stable Diffusion (SD) v1.5, DOODL, and FreeDoM. FIG. 10B shows example images 310 generated in the aesthetically guided sampling experiment.

The following table shows quantitative results obtained in the aesthetically guided sampling experiment:

| Method | Aesthetic loss (↓) |
|---|---|
| SD v1.5 | 9.71 |
| FreeDoM | 9.18 |
| DOODL | 9.78 |
| SAG | 8.17 |

As shown in the above table, SAG has the lowest aesthetic loss among the tested methods.

Personalization experiments were also performed, including an object-guided sampling experiment and a face-ID-guided sampling experiment. When computing the guidance loss in the object-guided sampling experiment, a spherical distance loss was used to compute the distance between image features of generated images and reference images obtained from a ViT-H-14 CLIP model. Stable Diffusion was used as the denoising diffusion model, and the pretrained integration timestep count was set to n=4. The number of denoising timesteps was set to T=100, with guidance applied from steps t=100 to t=31. The numbers of self-recurrence iterations were set to rₜ=2 from denoising timesteps 100 to 31.

The results of SAG were compared to DOODL, FreeDoM, and DreamBooth in the object-guided sampling experiment. The DreamBooth fine-tuning approach was used to fine-tune the denoising diffusion model for 400 steps on one training sample with a learning rate of 1×10⁻⁶. Model performance was measured using the cosine similarity between CLIP embeddings of the generated images and the reference images (denoted as CLIP-I), as well as the cosine similarity between CLIP embeddings of the generated images and the given text prompts (denoted as CLIP-T). For reference dog images were randomly selected, along with four prompts: “A dog (at the Acropolis/swimming/in a bucket/wearing sunglasses).” Four images were generated per prompt per image. FIG. 10C shows example images 320 generated in the object-guided sampling experiment.

The following table shows quantitative results for the object-guided sampling experiment:

| Method | CLIP-I (↑) | CLIP-T (↑) |
|---|---|---|
| DreamBooth | 0.724 | 0.277 |
| FreeDoM | 0.681 | 0.281 |
| DOODL | 0.743 | 0.277 |
| SAG | 0.774 | 0.270 |

As shown in the above table, the images generated with SAG have the highest CLIP image similarity with the reference images. Although the text similarity scores of the four methods are close to each other, FreeDoM achieves the highest similarity to the text prompt.

In another personalization experiment, face-ID-guided sampling was performed. In the face-ID-guided sampling experiment, ArcFace was used to extract target features of reference faces to represent face IDs. In addition, ArcFace was used to extract features of the guided image. The loss function was an l₂ Euclidean distance between the extracted face ID features of the reference image and the guided image. The pretrained integration timestep count was set to n=5. Five face IDs were randomly selected, and 200 faces for each face ID were generated. The face-ID-guided generation results computed using SAG were compared with those computed using FreeDoM, as indicated by loss and Fréchet inception distance (FID). FIG. 10D shows example images 330 computed in the face-ID-guided generation experiment.

The following table shows quantitative results for the face-ID guided sampling experiment:

| Method | ID loss (↓) | FID (↓) |
|---|---|---|
| FreeDoM | 0.602 | 65.24 |
| SAG | 0.574 | 64.25 |

As shown in the above table, SAG outperforms FreeDoM in terms of both ID loss and FID.

A style-guided video editing experiment was also performed. In the style-guided video editing experiment, MagicEdit was used as the denoising diffusion model. Given an input video, a depth map was extracted, and MagicEdit was used to generate a video with motion that matched that of the input video, conditioned on the depth map and a text prompt. As in the style-guided sampling experiment, an L₂ loss was computed between the Gram matrices of the generated images and the reference image. Since the depth map and text prompt provide large amounts of information about the final output video, the number of denoising timesteps was set to T=25. MagicEdit was used to render a video of 16 frames, with each frame having dimensions of 256×256 pixels. SAG guidance was applied at denoising timesteps t∈[20, 10].

FIG. 10E shows example guided frames 340 generated in the style-guided video editing experiment. As shown in FIG. 10E, SAG enables MagicEdit to generate videos of specific styles (e.g., a cat in the Chinese papercut style). In contrast, without SAG, the base editing model can barely synthesize videos whose color and texture align with the reference image.

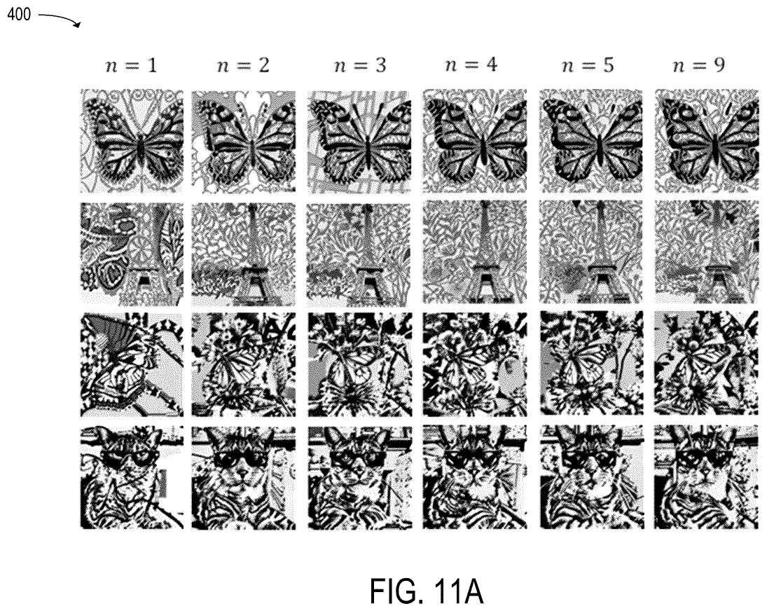

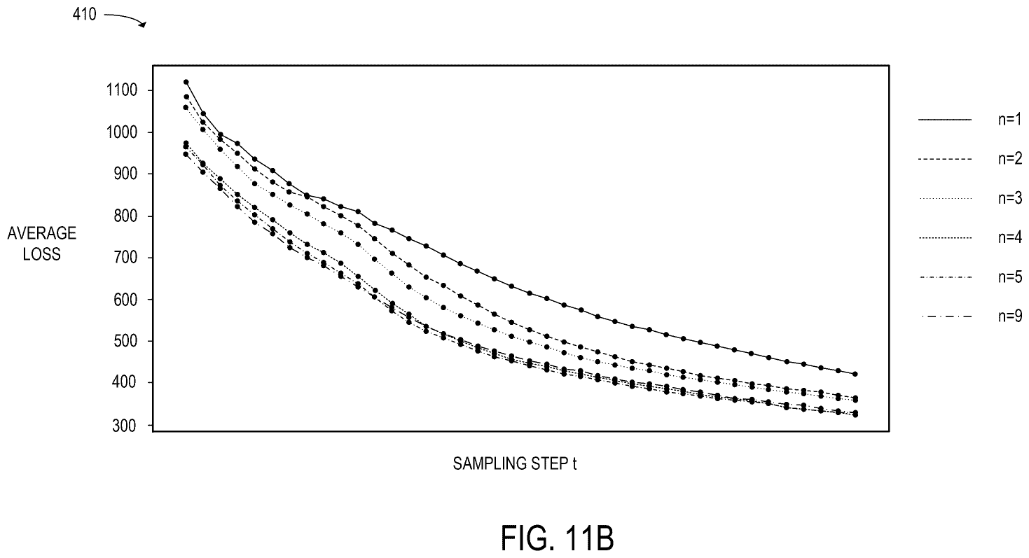

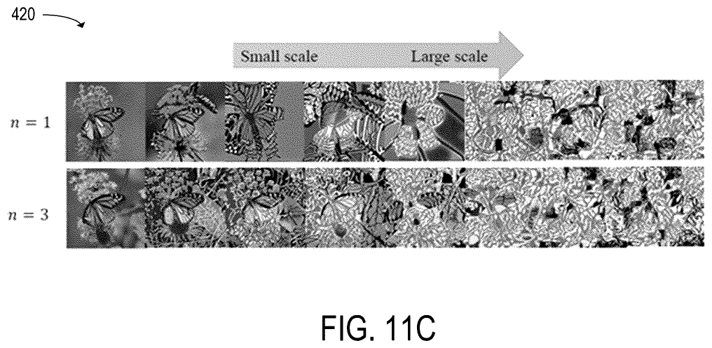

Experiments were also performed to test the effects of different choices of hyperparameter values. One such experiment tested different values of the predefined integration timestep count n. This experiment was performed using the image stylization task, with T=100 and with guidance performed from steps 70 to 31. The prompts “A cat wearing glasses,” “butterfly,” and “a photo of an Eiffel Tower” were used to generate 20 stylized images for each of the tested values of n. Example result images 400 are shown in FIG. 11A. In addition, FIG. 11B shows a plot 410 of loss curves for different values of n. As shown in FIG. 11A, the generated images undergo content distortion and less obvious stylization effects when n=1. As n increases, the quality of the generated images also increases, and the reduction in loss between generated images and style images becomes more prominent. However, loss stops decreasing significantly when n is increased beyond 4.

Another experiment tested different values of the guidance strength hyperparameter ρₜ. The image stylization task was again used as the example task, with values of n equal to 1 and 3. The guidance strength hyperparameter ρₜ was gradually increased from 0.3 to 0.5. FIG. 11C shows example images 420 generated at different values of the guidance strength hyperparameter ρₜ. As depicted in FIG. 11C, the stylization becomes more obvious as the guidance strength hyperparameter ρₜ increases, but the generated images suffer from severe artifacts at high values of ρₜ.

Experiments were also performed to test different ranges of denoising timesteps at which to perform guidance, as well as to test different numbers of self-recurrence timesteps. As discussed above, the diffusion sampling process roughly includes three stages: the chaotic stage where xₜ is highly noisy, the semantic stage at which semantic features of the image appear, and the refinement stage at which changes in the generated results are minimal. Increasing the number of self-recurrence timesteps rₜ extends the diffusion sampling process and helps to explore results that achieve both guidance and image quality. Thus, in tasks such as stylization and aesthetic guidance where the semantic content of the input image is retained, a low value of rₜ may be used in the semantic stage (e.g., rₜ=2). In contrast, for tasks such as object-guided or face-ID-guided personalization, guidance may also be performed at the chaotic stage, and larger values of rₜ (e.g., rₜ=3) may be used.

The SAG approach, as discussed above, allows guided image generation to be performed at a denoising diffusion model in a manner that does not require additional diffusion model training. SAG also avoids misalignment between generated images and estimated clean images, thereby achieving higher image quality and reductions in image artifacts. SAG also allows guided images to be generated in a memory-efficient manner that incorporates information from prior-timestep generated images without having to concurrently store a sequence of multiple prior-timestep generated images in volatile memory. Thus, SAG allows for efficient computation of high-quality guided images.

In some embodiments, the methods and processes described herein may be tied to a computing system of one or more computing devices. In particular, such methods and processes may be implemented as a computer-application program or service, an application-programming interface (API), a library, and/or other computer-program product.

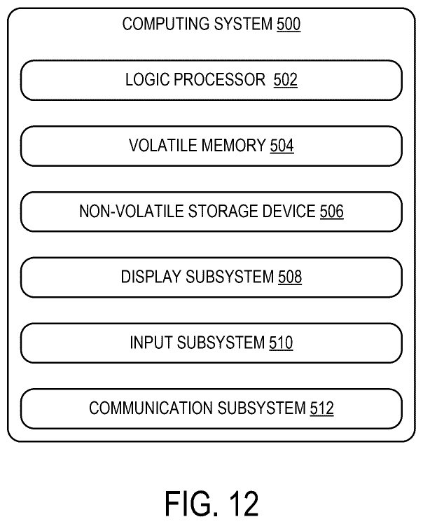

FIG. 12 schematically shows a non-limiting embodiment of a computing system 500 that can enact one or more of the methods and processes described above. Computing system 500 is shown in simplified form. Computing system 500 may embody the computing system 10 described above and illustrated in FIG. 1. Computing system 500 may take the form of one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 500 includes a logic processor 502 volatile memory 504, and a non-volatile storage device 506. Computing system 500 may optionally include a display subsystem 508, input subsystem 510, communication subsystem 512, and/or other components not shown in FIG. 12.

Logic processor 502 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 502 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 506 includes one or more physical devices configured to hold instructions executable by the logic processors to implement the methods and processes described herein. When such methods and processes are implemented, the state of non-volatile storage device 506 may be transformed—e.g., to hold different data.

Non-volatile storage device 506 may include physical devices that are removable and/or built-in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. Non-volatile storage device 506 is configured to hold instructions even when power is cut to the non-volatile storage device 506.

Volatile memory 504 may include physical devices that include random access memory. Volatile memory 504 is typically utilized by logic processor 502 to temporarily store information during processing of software instructions. It will be appreciated that volatile memory 504 typically does not continue to store instructions when power is cut to the volatile memory 504.

Aspects of logic processor 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via logic processor 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with logic processor 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 500 to send and/or receive messages to and/or from other devices via a network such as the Internet.

The following paragraphs provide additional description of the subject matter of the present disclosure. According to one aspect of the present disclosure, a computing system is provided, including one or more processing devices configured to receive an image generation prompt and receive a reference image. Over a plurality of denoising timesteps, the one or more processing devices are further configured to compute a guided image at least in part by iteratively applying a plurality of denoising updates to a generated image at a denoising diffusion model. At a subset of the plurality of denoising timesteps, computing the guided image further includes applying respective guidance updates to the generated image based at least in part on the image generation prompt, the reference image, and a generated image set that includes a current-timestep generated image and a plurality of prior-timestep generated images. The one or more processing devices are configured to compute each guidance update at least in part by performing a forward pass over the generated image set in a plurality of first integration timesteps and performing a backward pass over the generated image set in a plurality of second integration timesteps. A size of the generated image set, a number of the first integration timesteps, and a number of the second integration timesteps are each equal to a predefined integration timestep count. The one or more processing devices are further configured to output, as the guided image, a final generated image computed in a final denoising timestep of the plurality of denoising timesteps. The above features may have the technical effect of performing guided image generation without requiring additional training of the denoising diffusion model. The technical effects may further include an increase in memory efficiency and a reduction in image artifacts.

According to this aspect, the one or more processing devices may be configured to compute each of the guidance updates as a product of a guidance strength hyperparameter and a gradient of a guidance loss. The above features may have the technical effect of generating the guided image with an adjustable guidance strength.

According to this aspect, performing the forward pass may include computing an estimated clean image based at least in part on the generated image set. The guidance loss may be computed based at least in part on the estimated clean image and the reference image. The above features may have the technical effect of guiding image denoising using a loss function that depends on the reference image.

According to this aspect, performing the forward pass may include numerically solving a first ordinary differential equation (ODE) over the plurality of first integration timesteps. Performing the backward pass may include numerically solving a second ODE over the plurality of second integration timesteps. The above features may have the technical effect of computing the estimated clean image and the gradient of the guidance loss.

According to this aspect, the one or more processing devices may be configured to solve the first ODE and the second ODE using a symplectic Euler method or a symplectic Runge-Kutta method. The above features may have the technical effect of computing the estimated clean image and the gradient in a memory-efficient manner.

According to this aspect, the one or more processing devices may be configured to compute the guidance update based at least in part on a noise scheduling hyperparameter that varies over the plurality of denoising timesteps. The above feature may have the technical effect of varying the amount of noise applied to the generated images at different denoising timesteps.

According to this aspect, the one or more processing devices may be configured to apply the guidance updates at a plurality of intermediate denoising timesteps that are preceded by a plurality of initial denoising timesteps and followed by a plurality of subsequent denoising timesteps. The above features may have the technical effect of timing the guidance of the image generation process such that the guidance affects the semantic content of the guided image.

According to this aspect, at one or more of the denoising timesteps, the one or more processing devices may be configured to repeat denoising and noise addition for the generated image at each of a plurality of self-recurrence timesteps. The above features may have the technical effect of reducing visual artifacts that would otherwise occur as a result of adding the guidance update to the generated image.

According to this aspect, the one or more processing devices are configured to compute and apply the guidance update at one or more of the self-recurrence timesteps. The above features may have the technical effect of reducing artifacts in the guided image by performing both self-recurrence and guidance at the same denoising timesteps.

According to this aspect, the reference image may be a style transfer reference image or a subject personalization reference image. The above features may have the technical effect of performing style transfer on the generated images or inserting a user-selected subject into the generated images.

According to this aspect, the one or more processing devices may be further configured to receive an input video including a plurality of frames and compute respective depth maps of the frames of the input video. Based at least in part on the depth maps, the one or more processing devices may be further configured to compute a guided video including a plurality of guided frames. The one or more processing devices may be further configured to output the guided video. The above features may have the technical effect of performing guided video generation.

According to another aspect of the present disclosure, a method for use with a computing system is provided, including receiving an image generation prompt and receiving a reference image. Over a plurality of denoising timesteps, the method further includes computing a guided image at least in part by iteratively applying a plurality of denoising updates to a generated image at a denoising diffusion model. At a subset of the plurality of denoising timesteps, the method further includes applying respective guidance updates to the generated image based at least in part on the image generation prompt, the reference image, and a generated image set that includes a current-timestep generated image and a plurality of prior-timestep generated images. Computing each guidance update includes performing a forward pass over the generated image set in a plurality of first integration timesteps and performing a backward pass over the generated image set in a plurality of second integration timesteps. A size of the generated image set, a number of the first integration timesteps, and a number of the second integration timesteps are each equal to a predefined integration timestep count. The method further includes outputting, as the guided image, a final generated image computed in a final denoising timestep of the plurality of denoising timesteps. The above features may have the technical effect of performing guided image generation without requiring additional training of the denoising diffusion model. The technical effects may further include an increase in memory efficiency and a reduction in image artifacts.

According to this aspect, each of the guidance updates may be computed as a product of a guidance strength hyperparameter and a gradient of a guidance loss. The above features may have the technical effect of generating the guided image with an adjustable guidance strength.

According to this aspect, performing the forward pass may include computing an estimated clean image based at least in part on the generated image set. The guidance loss may be computed based at least in part on the estimated clean image and the reference image. The above features may have the technical effect of guiding image denoising using a loss function that depends on the reference image.

According to this aspect, performing the forward pass may include numerically solving a first ordinary differential equation (ODE) over the plurality of first integration timesteps. Performing the backward pass may include numerically solving a second ODE over the plurality of second integration timesteps. The above features may have the technical effect of computing the estimated clean image and the gradient of the guidance loss.

According to this aspect, the guidance update may be computed based at least in part on a noise scheduling hyperparameter that varies over the plurality of denoising timesteps. The above feature may have the technical effect of varying the amount of noise applied to the generated images at different denoising timesteps.

According to this aspect, guidance updates may be applied at a plurality of intermediate denoising timesteps that are preceded by a plurality of initial denoising timesteps and followed by a plurality of subsequent denoising timesteps. The above features may have the technical effect of timing the guidance of the image generation process such that the guidance affects the semantic content of the guided image.

According to this aspect, the reference image may be a style transfer reference image or a subject personalization reference image. The above features may have the technical effect of performing style transfer on the generated images or inserting a user-selected subject into the generated images.

According to this aspect, the method may further include receiving an input video including a plurality of frames and computing respective depth maps of the frames of the input video. Based at least in part on the depth maps, the method may further include computing a guided video including a plurality of guided frames. The method may further include outputting the guided video. The above features may have the technical effect of performing guided video generation.

According to another aspect of the present disclosure, a computing system is provided, including one or more processing devices configured to receive an image generation prompt. Over a plurality of denoising timesteps, the one or more processing devices are further configured to compute a guided image at least in part by iteratively applying a plurality of denoising updates to a generated image at a denoising diffusion model. At a subset of the plurality of denoising timesteps, computing the guided image further includes, at a trained feedback model, computing a feedback model reward value based at least in part on a current-timestep generated image. At the subset of the plurality of denoising timesteps, computing the guided image further includes applying respective guidance updates to the generated image based at least in part on the image generation prompt, the feedback model reward value, and a generated image set that includes a current-timestep generated image and a set of prior-timestep generated images. The one or more processing devices are configured to compute each guidance update at least in part by performing a forward pass over the generated image set in a plurality of first integration timesteps and performing a backward pass over the generated image set in a plurality of second integration timesteps. A size of the generated image set, a number of the first integration timesteps, and a number of the second integration timesteps are each equal to a predefined integration timestep count. The one or more processing devices are further configured to output, as the guided image, a final generated image computed in a final denoising timestep of the plurality of denoising timesteps. The above features may have the technical effect of performing guided image generation without requiring additional training of the denoising diffusion model. The technical effects may further include an increase in memory efficiency and a reduction in image artifacts.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive an image generation prompt;
receive a reference image;
over a plurality of denoising timesteps, compute a guided image at least in part by:
iteratively applying a plurality of denoising updates to a generated image at a denoising diffusion model; and
at a subset of the plurality of denoising timesteps, applying respective guidance updates to the generated image based at least in part on the image generation prompt, the reference image, and a generated image set that includes a current-timestep generated image and a plurality of prior-timestep generated images, wherein the one or more processing devices are configured to compute each guidance update at least in part by:
performing a forward pass over the generated image set in a plurality of first integration timesteps; and
performing a backward pass over the generated image set in a plurality of second integration timesteps, wherein a size of the generated image set, a number of the first integration timesteps, and a number of the second integration timesteps are each equal to a predefined integration timestep count; and
output, as the guided image, a final generated image computed in a final denoising timestep of the plurality of denoising timesteps.

2. The computing system of claim 1, wherein the one or more processing devices are configured to compute each of the guidance updates as a product of a guidance strength hyperparameter and a gradient of a guidance loss.

3. The computing system of claim 2, wherein:
performing the forward pass includes computing an estimated clean image based at least in part on the generated image set;
the guidance loss is computed based at least in part on the estimated clean image and the reference image.

4. The computing system of claim 1, wherein:
performing the forward pass includes numerically solving a first ordinary differential equation (ODE) over the plurality of first integration timesteps; and
performing the backward pass includes numerically solving a second ODE over the plurality of second integration timesteps.

5. The computing system of claim 4, wherein the one or more processing devices are configured to solve the first ODE and the second ODE using a symplectic Euler method or a symplectic Runge-Kutta method.

6. The computing system of claim 1, wherein the one or more processing devices are configured to compute the guidance update based at least in part on a noise scheduling hyperparameter that varies over the plurality of denoising timesteps.

7. The computing system of claim 1, wherein the one or more processing devices are configured to apply the guidance updates at a plurality of intermediate denoising timesteps that are preceded by a plurality of initial denoising timesteps and followed by a plurality of subsequent denoising timesteps.

8. The computing system of claim 1, wherein, at one or more of the denoising timesteps, the one or more processing devices are configured to repeat denoising and noise addition for the generated image at each of a plurality of self-recurrence timesteps.

9. The computing system of claim 8, wherein the one or more processing devices are configured to compute and apply the guidance update at one or more of the self-recurrence timesteps.

10. The computing system of claim 1, wherein the reference image is a style transfer reference image or a subject personalization reference image.

11. The computing system of claim 1, wherein the one or more processing devices are further configured to:
receive an input video including a plurality of frames;
compute respective depth maps of the frames of the input video;
based at least in part on the depth maps, compute a guided video including a plurality of guided frames; and
output the guided video.

12. A method for use with a computing system, the method comprising:
receiving an image generation prompt;
receiving a reference image;
over a plurality of denoising timesteps, computing a guided image at least in part by:
iteratively applying a plurality of denoising updates to a generated image at a denoising diffusion model; and
at a subset of the plurality of denoising timesteps, applying respective guidance updates to the generated image based at least in part on the image generation prompt, the reference image, and a generated image set that includes a current-timestep generated image and a plurality of prior-timestep generated images, wherein computing each guidance update includes:
performing a forward pass over the generated image set in a plurality of first integration timesteps; and
performing a backward pass over the generated image set in a plurality of second integration timesteps, wherein a size of the generated image set, a number of the first integration timesteps, and a number of the second integration timesteps are each equal to a predefined integration timestep count; and
outputting, as the guided image, a final generated image computed in a final denoising timestep of the plurality of denoising timesteps.

13. The method of claim 12, wherein each of the guidance updates is computed as a product of a guidance strength hyperparameter and a gradient of a guidance loss.

14. The method of claim 13, wherein:
performing the forward pass includes computing an estimated clean image based at least in part on the generated image set;
the guidance loss is computed based at least in part on the estimated clean image and the reference image.

15. The method of claim 12, wherein:
performing the forward pass includes numerically solving a first ordinary differential equation (ODE) over the plurality of first integration timesteps; and
performing the backward pass includes numerically solving a second ODE over the plurality of second integration timesteps.

16. The method of claim 12, wherein the guidance update is computed based at least in part on a noise scheduling hyperparameter that varies over the plurality of denoising timesteps.

17. The method of claim 12, wherein guidance updates are applied at a plurality of intermediate denoising timesteps that are preceded by a plurality of initial denoising timesteps and followed by a plurality of subsequent denoising timesteps.

18. The method of claim 12, wherein the reference image is a style transfer reference image or a subject personalization reference image.

19. The method of claim 12, further comprising:
receiving an input video including a plurality of frames;
computing respective depth maps of the frames of the input video;
based at least in part on the depth maps, computing a guided video including a plurality of guided frames; and
outputting the guided video.

20. A computing system comprising:
one or more processing devices configured to:
receive an image generation prompt;
over a plurality of denoising timesteps, compute a guided image at least in part by:
iteratively applying a plurality of denoising updates to a generated image at a denoising diffusion model; and
at a subset of the plurality of denoising timesteps:
at a trained feedback model, computing a feedback model reward value based at least in part on a current-timestep generated image; and
applying respective guidance updates to the generated image based at least in part on the image generation prompt, the feedback model reward value, and a generated image set that includes a current-timestep generated image and a set of prior-timestep generated images, wherein the one or more processing devices are configured to compute each guidance update at least in part by:
performing a forward pass over the generated image set in a plurality of first integration timesteps; and
performing a backward pass over the generated image set in a plurality of second integration timesteps, wherein a size of the generated image set, a number of the first integration timesteps, and a number of the second integration timesteps are each equal to a predefined integration timestep count; and
output, as the guided image, a final generated image computed in a final denoising timestep of the plurality of denoising timesteps.
